(19) United States
(12) Patent Application Publication
(10) Pub. No.: US 2023/0334539 A1
(43) Pub. Date: Oct. 19, 2023

(54) SYSTEM AND METHOD FOR ONLINE REPUTATION MANAGEMENT SYSTEM

(71) Applicant: Debasis Chatterji, Hyderabad (IN)

(72) Inventor: Debasis Chatterji, Hyderabad (IN)

(73) Assignee: Hybrid Mind India Private Limited, Hyderabad (IN)

(21) Appl. No.: 18/136,444

(22) Filed: Apr. 19, 2023

(30) Foreign Application Priority Data
Apr. 19, 2022 (IN) 202241023098

(51) Int. Cl. G06Q 30/0282; G06Q 50/00

(52) U.S. Cl. CPC G06Q 30/0282; G06Q 50/01

(57) ABSTRACT

A system executed in a network environment for measuring and monitoring the social acceptance of a brand reputation are disclosed. A user registers in a digital platform and selects a default Reputation Assessment Template (RAT) or creates a new RAT. The system generates an identification code for a set survey parameter with RAT and pushes a link to user's personal networking site. The user shares the link to their contacts. The responders click the link to open the RAT and submit the review. The system allows the responders to furnish honest feedback without spoiling the relationship with reviewee by maintaining complete anonymity of the reviewer. A confidence score and corresponding status statement are generated based on the analyzed response along with industry benchmark, strengths and weaknesses. Further, the system rewards reviewee and reviewer with a badge of excellence to be shared in social media for a wider audience as a token of achieving an industry standard.

### CROSS-REFERENCE TO RELATED APPLICATION

The present application claims priority to Indian Complete Patent Application No. 202241023098 filed on Apr. 19, 2022, the entire contents of which are hereby incorporated by reference for all purposes.

### FIELD OF THE INVENTION

The present invention generally relates to fully automated recurring online survey with a reputation management tool. After every cycle of survey/campaign a confidence score is published (already patented by us) and strength and weakness of the reviewee is published to make the customer/company connect more real-time, realistic and action-oriented improvement. Unlike standard survey, we don't use questionnaire. But, use attribute sets wherein we capture the feeling of the reviewers in both qualitative as well as quantitative way through ultrafast sliding bar mechanism (zero review writing). More specifically, the present invention relates to a system and method to measure and monitor the social acceptance of a personal/professional or brand reputation by respondents, thereby improving and increasing customer connection through an impactful reputation management practice and confidence building mechanism through corrective action.

### BACKGROUND

An online survey is a popular data collection source, where a set of survey information is sent to a target sample and the member of this sample respond to the survey over the internet. These surveys are mostly done via various mediums such as websites, social media, e-mail, etc. These are designed by various organizations either by themselves or by their agencies at a cost, in order to gain insights of customer psyche and to get feedback about upcoming products or services. It creates an opportunity for the brand to understand its target market more minutely to place the brand properly to achieve commercial success through the survey. Most of the organizations depend on the data received and analyzed from the online survey to make certain changes in their activities and style of functions.

There exist various tools for collecting feedback from users using an online survey. Few existing patent references attempted to address the problems cited in the background as prior art over the presently disclosed subject matter and are explained as follows:

A prior art US 20190156358 A1 assigned to Rob Pace entitled “Graphical user interfaces for adaptive feedback” discloses systems and methods for improving graphical user interfaces for providing adaptive feedback displays are described herein. In one aspect, the present disclosure relates to computer-implemented techniques for obtaining feedback data from users of a product, process, or service, associating the feedback data with net promoter or other score values, performing analytic reporting based on the feedback data, and dynamically modifying the manner of obtaining the feedback data.

Another prior art US 20120130863 A1 assigned to Steven Tedjamulia, et. al., entitled “Social Reputation” discloses a method and system is disclosed for conducting electronic commerce within a social media environment. A user of a social media site elects to perform an activity associated with a social commerce site. Once the social commerce activity has been performed, its corresponding value is processed with social commerce reputation data associated with the user to generate a social commerce reputation score for the user. The resulting social commerce reputation score is then compared to the requirements associated with different social commerce reputation badges. The social commerce reputation badge that matches the user's current social commerce reputation score is then displayed as a graphical image within the social commerce site along with the user's associated social commerce reputation data.

Another prior art US 20150006546 A1 assigned to Greg Klein, et. al., entitled “System and method for evaluating and improving social relationships” disclose a system, device, and method to evaluate and improve relationships. The system, device, and method help users evaluate their relationships with reduced emotional and personal bias. Users can also see how other users see the relationship with them, moreover users can get a score on their social skills and advice to improve them.

Another prior art US 20140310062 A1 assigned to Steven Tedjamulia, et. al., entitled “System and method for analysis and feedback within a large user community using surveys” discloses an improved methodology, system, and computer program for offering surveys and collecting and analyzing survey results that allow an organization to generate new surveys in an iterative manner based upon user feedback and crowdsourcing methodologies. In this manner, an organization relying upon survey results can gain greater insight into selected users, clients, and projects. The system according to the disclosed embodiments utilizes crowdsourcing methodologies to collect data from a variety of users and sources, whereby the data can be analyzed using innovative intelligence gathering and management techniques.

Though the above prior art discloses various systems and methods for receiving feedback for the product or service or process from the users. None of them disclose a system that measures and monitors the social acceptance of a brand reputation anonymously. Further, it does not disclose a system that receives feedback in a continuous automated process for any entity. Also, a system that uses predetermined product/service expressions i.e., reputation assessment temple as per the particular profession or business in terms of good or bad experience to calculate confidence score is disclosed.

Current innovation not only captures the state of mind of a respondent in terms of either happy or unhappy experience (qualitative) of a given attribute but also captures how much weightage the reviewer is emphasizing on it(quantitative) making the survey more robust, realistic and authentic.

Further, online surveys although a potent tool suffers from many disadvantages namely complexity, anonymity, boredom as well as lack of understanding on the part of the respondents, expertise and time consumption in framing questions by the sender, informal nature of the process, etc. to name a few. There is a huge market in the small and medium business (SMB) group, dealer, distributor and collective bodies such as club, gym, association, school, college, coaching center, etc. for whom understanding their target customer is extremely important but somehow probably they can't think of it. Similarly, individuals and professionals like doctors, engineers, teachers, chartered accountants, lawyer etc. Who would also be interested to know how their friends and clients think about individual/professional and send them honest feedback with the objective to provide a better service. A formal survey is usually expensive, time-consuming, and requires typical expertise in terms of survey design, analysis, and interpretation.

Therefore, there is a need for a system and method that measures and monitors the social acceptance of a professional reputation or brand reputation. Also, there is a need for a system that performs an online survey to analyze the responder's view and the feedback of a brand reputation in a lightning-fast method with zero writing efforts by the reviewers. Further, there is a need for a system and method to understand the public opinion about the product or service, or brand of an individual or an entity continuously. Because external and internal environments are changing continuously with time and therefore one-time periodical surveys with time gap are becoming less meaningful to come to correct conclusion. Thus, any corrective action taken by the organization/professionals may not yield any optimum result.

Also, there must be some built in social incentive process both for the reviewee (sender) as well as reviewer (respondent). A reviewee with a good standard must be publicized to attract more customers. similarly, an honest reviewer must be rewarded for reviewing a number of company/professional. They help other buyers in terms of correct product or service recommendation so that the other buyers can make the right buying decision. This reward and recognition system which can be propagated through social media is missing today.

### SUMMARY OF THE INVENTION

The present invention generally discloses an online survey tool. Also, the present invention discloses a system and method for measuring and monitoring the social acceptance of a personal or brand reputation by the respondents using a proprietary algorithm which converts structural expression feedback into a numerical value called confidence score (patent granted to us).

According to the present invention, the system is a computer-implemented system executed in a network environment for measuring and monitoring the social acceptance of a personal/professional or brand reputation, according to one embodiment of the present invention. The system provides an online survey or campaign for analyzing various responder's views and responses or feedback of a personal or brand reputation. In one embodiment, the system provides a digital platform for an online survey to understand the public opinion about the product or service, or brand. In one embodiment, further the system analyzes the responder's view using a confidence score. In one embodiment, the system allows the user to create a campaign by just clicking the category of sender to populate a typical reputation assessment template (RAT) specific to the profession or type of business automatically and share it with their respondents who can then rate different attributes pertaining to the brand reputation.

In one embodiment, the system is an application software or mobile application or, web-based application. In one embodiment, the application is executed in a computer-implemented environment or network environment. In one embodiment, the computer-implemented environment comprises user devices, a computing device, and a response analyzing system. Each user device is associated with a user. The user device is enabled to access the response analyzing system via a communication network. The user device has a user interface. In one embodiment, the user device is at least any one of a smartphone, a mobile phone, a laptop, a computer, a desktop, a tablet, or other suitable mobile and/or handheld electronic communication devices. In one embodiment, the user device comprises a storage medium in communication with the network to access the response analyzing system configured to analyze the plurality of responses received from the respondents. In an embodiment, the network may be a Wi-Fi network, a WiMAX network, a local area network (LAN), a wide area network (WAN), and a wireless local area network (WLAN).

In one embodiment, the response analyzing system comprises a server or computing device and one or more databases in communication with the computing device with an end-to-end encrypted technology so that no third party can access information about the reviewer and reviewee. In one embodiment, the computing device may be a cloud server. In one embodiment, the database is in communication with the computing device via the network. In one embodiment, the database is accessible by the server. In one embodiment, the computing device comprises a processor and computer-readable medium or memory unit coupled to the processor. The memory unit stores a set of instructions executable by the processor configured to provide communication between the users or senders in the digital platform to analyze the responder's view.

In one embodiment, the system allows the user or reviewee or sender, or initiator to create a user profile in the digital platform i.e., Confiscore. In one embodiment, the sender registers as per the category at the digital platform to establish credibility as an assessor. In one embodiment, the system is designed for use by people of all professions and age groups regardless of their technical knowledge. In one embodiment, the digital platform is used by individuals to measure how their friends are known, how people perceive them, or by a professional to understand how satisfied their clients are. It is also used by organizations and businesses to understand the public's opinion about their services or products or brands. In one embodiment, the user is any individual, any professional, any type of business or company, collective body like school, college, coaching center, gym, club, etc., or others. In one embodiment, the respondents are further any kind of entity.

In one embodiment, the system further includes a Reputation Assessment Template (RAT) in the digital platform. In one embodiment, the digital platform allows the users to pick a default or readymade RAT which is curated for their respective professions and use cases. In one embodiment, the RAT will appear automatically as per the category. Through these templates, the user can get a good understanding of their social reputation via their respondents. Moreover, the user can easily modify the RAT or create a new RAT as per their wish. This flexibility allows the user to design a campaign best suited to their needs with minimal effort.

In one embodiment, the system generates an identification code with a standard message. In one embodiment, the message is shared with code to different social networking sites of his/her choice where he is a member to attract the attention of his campaign from his peer group. In one embodiment, social networking is all about interaction, entertainment, exhibition, demonstration public endorsement, and advertisement. In addition, in social networking, there are lots of closed group activities. Further, social networking is a sort of a running commentary of any game and sports. In one embodiment, the digital platform of the present invention is a live soccer match where winning or losing is only determined by the scored goals. In one embodiment, further the system sets a survey parameter and pushes the link to his/her personal social networking site. In one embodiment, further the user shares the link from his/her personal account to his/her contacts (respondents).

In one embodiment, the sender will send the campaign notification through the mail, all social networking sites, messaging applications with the identification code which needs to be put in the Confiscore website or app. This will immediately link the responders to the sender's RAT. In one embodiment, the respondents can identify the notification from his known person and start responding to the campaign. In one embodiment, the respondents span across all age groups and may have extremely varied technical knowledge. Moreover, they may belong to a wide range of ethnic groups. Especially since the product is meant to be used in India, the respondents are likely to speak different languages and may not all be comfortable with English. Hence, the interface needs to be designed in a way that minimizes any issues the users might have due to this language barrier. It needs to be more visual and pictorial rather than being verbose. In one embodiment, the responders are selected by the senders.

In one embodiment, the respondents slide the button of the attribute bar to submit the response. For every typical category of the sender, a standard set of attributes are predefined under two sets of experience viz. good and bad. The respondent needs to slide the button on a line of expression in such a way that the longer the slide, the heavier the emphasis to be captured in the back end and vice versa. In one embodiment, the respondents have a choice of either sliding the button for a good experience or the bad experience for any attribute like value for money and not both simultaneously. In one embodiment, the respondents slide the button of the attribute bar to submit their response. In one embodiment, the system provides freedom and fearlessness to the reviewers to furnish an honest review without affecting the relationship with the reviewee by maintaining anonymity of the reviewer. In one embodiment, the sender will receive a Confidence score once the bar is slid by the responders and submitted only after the completion of a particular campaign cycle along with the strengths and weaknesses. In one embodiment, the system further includes an option to write briefly.

In one embodiment, the system further includes an algorithm to generate a confidence score (CS) along with a status statement for quick understanding. In one embodiment, the CS is expressed by a numerical value. In one embodiment, the numerical value ranges from 0.01 to 100. In one embodiment, the system further uses a proprietary algorithm to transform respondent's opinions into numbers for all the captured inputs. In one embodiment, the sender knows the social standing through CS numbers including the strengths and weaknesses determined by the respective respondents. In one embodiment, the CS of more than one means the overall confidence of the respondents is positive for the sender, and the higher the better. In one embodiment, a CS of less than one is negative confidence or lack of confidence. In one embodiment, the individuals and professionals can numerically track the movement of CS scored at different times. In one embodiment, this improves their personality and rapport among the respondents. Similarly, business and collective bodies can understand their customers better, develop trust, and thus build their brand resulting in more business. In one embodiment, the respondents include a friend, colleague, client, customer, user, etc., anyone who knows users or their business/brand well. A number of such campaign cycles will go on perpetually to improve the service of any entity in real time basis.

In one embodiment, along with CS, the sender gets to know about three top and bottom voted attributes in terms of his strengths and weaknesses guiding him on the path of improvement. Due to its simplicity, it can be conducted multiple times to monitor the score. In one embodiment. it also calculates the industry or sector or professional standard or benchmark CS for a particular type of business sector, a collective body, and individual or profession respectively so that a particular reviewee can see that in his personal dashboard and act upon it for further improvement.

In one embodiment, the system further provides or issues the users and responders with rewards and recognition for their effort. In one embodiment, the users and responders are rewarded with badges of excellence. In one embodiment, the badges of excellence are rewarded under different categories such as Bronze, Silver, Gold, and Diamond which are tagged and shared in social media as a mark of meaningful gratification. In one embodiment, a similar rule applies for the reviewee. In one embodiment, Reviewers/respondents are rewarded for honestly reviewing a certain number of reviews as a contribution to society. In on embodiment, the reviewees or senders maintain a certain Confidence Score for a certain period of time which will signify a set standard. In one embodiment, the badges of excellence are tagged & shared with personal profiles in social networking sites to boost digital recognition of the users and responders. The reviewee can also display badges of excellence in confiscore platform as advertisement at a cost. This will improve their social status and recognition in the eyes of the social media audience. It also generates comprehensive reports to monitor how the respondent's views change over time.

In one embodiment, the system further provides the user with a dashboard. In one embodiment, the user gets their personalized dashboard with detailed analysis, with every confidence score they get to know the top and bottom three voted attributes as a guiding path to handhold them for future perfection. In one embodiment, once a user opens an account, they will have a very detailed dashboard to review their campaign cycles. In one embodiment, the sender or reviewer can see a detailed analysis of his/her personal dashboard. For every typical category of the sender, a standard set of attributes are predefined under two sets of experience such as good and bad. In one embodiment, the sender will determine and implement the number of campaign cycles as well as the duration of each campaign.

In one embodiment, the system uses a method to measure and monitor the social acceptance of a brand reputation. The method comprises the following steps. At one step, the system allows a user/reviewee/sender and responder/reviewer to register in a digital platform i.e., Confiscore APP or mobile web, using one or more user credentials. In one embodiment, the digital platform is an online survey tool. At another, the user selects a default Reputation Assessment Template (RAT) or modifies or creates a new RAT in the digital platform. At another step, the system generates an identification code with a standard reputation management campaign process flow. At another step, the user sets a survey parameter or campaign with the reputation management template and pushes a link or a generated code to the user's personal social networking site. At another step, the user shares the link from the personal social networking site to the user's contacts i.e., the respondents. At another step, the respondents open the link to go to survey page directly to provide their feelings. At another step, the responders submit the review by sliding the button of the attribute bar. At another step, an end-to-end encryption technology is applied to make the entire process flow being completely safe and secure. At another step, the digital platform analyzes the received response and generates a confidence score. And at another step, the digital platform rewards the user and the responders with a badge of excellence for their maximum effort.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 shows a computer-implemented system executed in a network environment for measuring and monitoring social acceptance of a personal/professional or brand reputation in an embodiment of the present invention.

FIG. 2 shows a dashboard for individuals and professionals in one embodiment of the present invention.

FIG. 3 shows a dashboard for business and collective body in one embodiment of the present invention.

FIG. 4 shows a flowchart describing the experience of reviewee (sender) and reviewer (responder) for measuring and monitoring acceptance of the reputation of a brand or professional generated in one embodiment of the present invention.

FIG. 5 shows a method flow for analyzing responders view in an embodiment of the present invention.

### DETAILED DESCRIPTION OF EMBODIMENTS

The present invention is best understood by reference to the detailed figures and description set forth herein.

It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

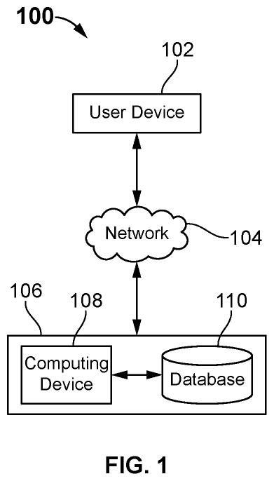

Referring to FIG. 1, a computer-implemented system executed in a network environment 100 for measuring and monitoring the social acceptance of a personal/professional or brand reputation, according to one embodiment of the present invention. The system runs in the computer-implemented environment 100 configured to provide an online survey or campaign for analyzing various responder's views and responses or feedback of a personal or brand reputation. In one embodiment, the system provides a digital platform for an online survey to understand the public opinion about the product or service, or brand. In one embodiment, further the system analyzes the responder's view using a confidence score. In one embodiment, the system allows the user to create a campaign and share it with their respondents who can then rate different attributes pertaining to the brand reputation. In one embodiment, any particular campaign is always from one to many

In one embodiment, the network environment 100 comprises one or more user devices 102. Each user device 102 is associated with a user. In one embodiment, the user device 102 is installed with a digital platform (i.e., Confiscore). In one embodiment, Confiscore is a type of e-mind application. In one embodiment, the digital platform may be an application software or mobile application or web-based application or software application. The system further comprises a network 104 and a response analyzing system 106. In one embodiment, the user device 102 is enabled to access the response analyzing system 106 via the network 104. In one embodiment, the user device 102 enables the user to access one or more services provided by the system. In one embodiment, the user device 102 is at least any one of a smartphone, a mobile phone, a tablet, a laptop, a desktop, and /or other suitable hand-held electronic communication devices. In one embodiment, the user device 102 comprises a storage medium in communication with the network 104 to access the response analyzing system 106. In an embodiment, the network 104 could be Wi-Fi, WiMAX, wireless local area network (WLAN), satellite networks, cellular networks, private networks, and the like.

In one embodiment, the response analyzing system 106 comprises a computing device 108 and one or more databases 110 in communication with the computing device 108. In one embodiment, the computing device 108 is a server. In one embodiment, the computing device 108 could be a cloud server. In one embodiment, the server could be operated as a single computer. In some embodiments, the computer could be a touchscreen and/or non-touchscreen and adopted to run on any type of OS, such as iOS™, Windows™, Android™, Unix™, Linux™, and/or others. In one embodiment, the plurality of computers is in communication with each other, via networks. Such communication is established via any one of application software, a mobile application, a browser, an OS, and/or any combination thereof.

In one embodiment, the database 110 is in communication with the computing device 108 via the network 104. In one embodiment, the database 110 is accessible by the computing device 108. In another embodiment, the database 110 is integrated into the computing device 108 or separate from it. In some embodiments, the database 110 resides in a connected server or a cloud computing service. Regardless of location, the database 110 comprises a memory to store and organize certain data for use by the computing device 108.

In one embodiment, the computing device 108 comprises a processor and a computer-readable medium or memory unit coupled to the processor. The memory unit stores a set of instructions executable by the processor configured to analyze various responder's views on the brand or personal reputation. The memory unit could be RAM, ROM (including EPROM, EEPROM, PROM). In one embodiment, the user devices 102 are configured to access the services provided by the computing device 108 via the network 104. In one embodiment, the computing device 108 is configured to provide communication between the users or senders in the digital platform to analyze the responder's view.

In one embodiment, the system allows the user or sender, or initiator to create a user profile in the digital platform i.e., Confiscore. In one embodiment, the sender registers as per the category at the digital platform to establish credibility as an assessor. In one embodiment, the system is designed for use by people of all professions and age groups regardless of their technical knowledge. In one embodiment, the digital platform is used by individuals to measure how their friends are known, how people perceive them, or by a professional to understand how satisfied their clients are. It is also used by organizations and businesses to understand the public's opinion about their services or products or brands. Further, it is used by bankers, architects, CEOs who might expect detailed and exhaustive reports. In one embodiment, the digital platform is also used as a potent tool for 360-degree analysis by HR of any organization. It is also used by homemakers, beauty parlor owners, and other small-scale business owners who may have limited technical skills. In one embodiment, the user is any individual, any professional, any type of business or company, collective body like school, college, coaching center, gym, club, etc., or others. In one embodiment, the respondents are further any kind of entity.

In one embodiment, the digital platform of the present invention is used for personal or organizational improvement, introspection, achievement, and accomplishment. In one embodiment, the digital platform is always the source of origin for a self-assessment test from the people known to them.

In one embodiment, the system further includes a Reputation Assessment Template (RAT) in the digital platform. In one embodiment, the digital platform allows the users to pick a default or readymade RAT which is curated for their respective professions and use cases. In one embodiment, the RAT will appear automatically as per the category. Through these templates, the user can get a good understanding of their social reputation via their respondents. Moreover, the user can easily modify the RAT or create a new RAT as per their wish. This flexibility allows the user to design a campaign best suited to their needs with minimal effort. In other embodiment the whole campaign management tool is end to end encrypted to ensure safety and security.

Generally, there are about ten attributes in an RAT. In one embodiment, the user can work on the attributes relevant to them. In one embodiment, the user can address all attributes if all are relevant. In one embodiment, the sender is also provided with an option of creating a new set of attributes for any informed business group. In one embodiment, these sets of expressions to be answered by reviewers are called Reputation Assessment Template or RAT.

In one embodiment, the system generates an identification code with a standard message. In one embodiment, the message is shared with code to different social networking sites of his/her choice where he is a member to attract the attention of his campaign from his peer group. In one embodiment, social networking is all about interaction, entertainment, exhibition, demonstration public endorsement, and advertisement. In addition, in social networking, there are lots of closed group activities. Further, social networking is a sort of a running commentary of any game and sports. In one embodiment, the digital platform of the present invention is a live soccer match where winning or losing is only determined by the scored goals. In one embodiment, further the system sets a survey parameter and pushes the link to his/her personal social networking site. In one embodiment, further the user shares the link from his/her personal account to his/her contacts (respondents).

In one embodiment, the sender will send the campaign notification through the mail, all social networking sites, messaging applications with the identification code which needs to be put in the Confiscore website or app. This will immediately link the responders to the sender's RAT. In one embodiment, the respondents can identify the notification from his known person and start responding to the campaign. In one embodiment, the respondents span across all age groups and may have extremely varied technical knowledge. Moreover, they may belong to a wide range of ethnic groups. Especially since the product is meant to be used in India, the respondents are likely to speak different languages and may not all be comfortable with English. Hence, the interface needs to be designed in a way that minimizes any issues the users might have due to this language barrier. It needs to be more visual and pictorial rather than being verbose. In one embodiment, the responders are selected by the senders.

In one embodiment, the respondents slide the button of the attribute bar to submit the response. For every typical category of the sender, a standard set of attributes are predefined under two sets of experience viz. good and bad. The respondent needs to slide the button on a line of expression in such a way that the longer the slide, the heavier the emphasis to be captured in the back end. In one embodiment, the respondents have a choice of either sliding the button for a good experience or the bad experience for any attribute like value for money and never both simultaneously. In one embodiment, the respondents slide the button of the attribute bar to submit their response. In one embodiment, the sender will receive a Confidence score once the bar is slid by the responders along with strengths and weaknesses after the completion of the campaign. In one embodiment a confidence score will be generated after the completion of one and each campaign cycle. In one embodiment, the system further includes an option to write briefly.

In one embodiment, the system further includes an algorithm to generate a confidence score (CS). In one embodiment, the CS is expressed by a numerical value. In one embodiment, the numerical value ranges from 0.01 to 100. In one embodiment, the system further uses a proprietary algorithm to transform respondent's opinions into numbers for all the captured inputs. In one embodiment, the sender knows the social standing through CS numbers including the strengths and weaknesses determined by the respective respondents. In one embodiment, the CS of more than one means the overall confidence of the respondents is positive for the sender, and the higher the better. In one embodiment, a CS of less than one is negative confidence or simply no confidence. In one embodiment, with each confidence score algorithm will generate a status statement for the reviewee. In one embodiment, the individuals and professionals can numerically track the movement of CS scored at different times and change of status statement. In one embodiment, this improves their personality and rapport among the respondents. Similarly, business and collective bodies can understand their customers better, develop trust, and thus build their brand resulting in more business in real time continuously by working on strength and weakness analysis. In one embodiment, the respondents include a friend, colleague, client, customer, user, etc., anyone who knows users or their business/brand well. In one embodiment, respondents or reviewers can honestly and without any prejudice furnish their honest and frank feedback because their relationship with the sender or reviewee will not be spoiled. This is made possible by maintaining complete anonymity of the reviewer. Plus, end to end encryption technology will maintain full safety and security so that no third party can get access to the information shared by either reviewee or by reviewer.

In one embodiment, along with CS, the sender gets to know about three top and three bottom voted attributes in terms of his strengths and weaknesses guiding him on the path of improvement. Due to its simplicity, it can be conducted multiple times to monitor the score. In one embodiment, to make the score more easily meaningful a status statement is also published automatically along with each confidence score. In one embodiment. it also calculates the industry or sector or professional standard or an industry benchmark for a particular type of business sector, collective body, and individual or profession respectively so that a particular reviewee can see that in his personal dashboard and act upon it for further improvement.

In one embodiment, each campaign once created will last for a few days to get a CS as per the choice of the sender. The time span for which each campaign will BE live is called the campaign cycle. In one embodiment, the respondents can work on the campaign anytime within each campaign cycle. In one embodiment, the sender can also select the number of campaign cycles for a particular campaign. In one embodiment, the campaign cycle can be fixed from a drop-down menu. One can run the same campaign in multiple cycles to get many CS. Further, Multiple CS will be calculated through the system automation, and depending on the sector, at a specific interval system analytics will calculate the CS by picking up the submitted RAT parameters. In one embodiment, depending on the sector at a specific interval the system analytics will calculate the CS by picking up the submitted RAT parameters. This allows the system to measure and monitor CS. In one embodiment, the individuals and professionals can numerically track the movement of CS at different points of time. They can improve their personality and rapport among friends, colleagues, and clients. Similarly, business and collective bodies can understand their customers better, develop trust and thus build their brand resulting in more business.

In one embodiment, the CS with different digits may not necessarily trigger a clear-cut understanding of their status to the reviewee or sender. Therefore, CS is grouped in different ranges and each range is further supplemented with a meaningful statement of gratification. Further, the sender gets to know his strengths and weaknesses as per the reviews of the reviewers.

In one embodiment, the system further provides or issues the users and responders with rewards and recognition for their effort. In one embodiment, the users and responders are rewarded with badges of excellence. In one embodiment, the badges of excellence are rewarded under different categories such as Bronze, Silver, Gold, and Diamond which are tagged and shared in social media as a mark of meaningful gratification. In one embodiment, a similar rule applies for the reviewee. In one embodiment, Reviewers/respondents are rewarded for honestly reviewing a certain number of reviews as a contribution to society. In on embodiment, the reviewees or senders maintain a certain Confidence Score for a certain period of time which will signify a set standard. In one embodiment, the badges of excellence are tagged & shared with personal profiles in social networking sites to boost digital recognition of the users and responders. This will improve their social status and recognition in the eyes of the social media audience. It also generates comprehensive reports to monitor how the respondent's views change over time.

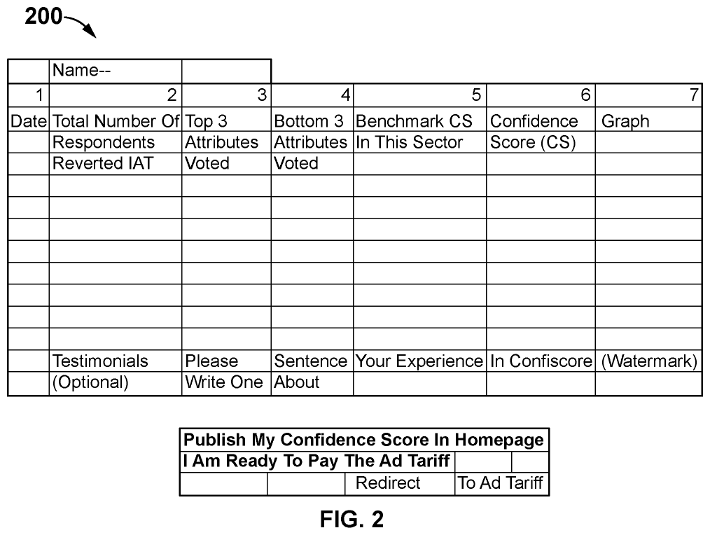

Referring to FIG. 2, shows a dashboard 200 for individuals and professionals, according to one embodiment. In one embodiment, the user gets their personalized dashboard 200 with detailed analysis, with every Confidence Score they get to know the top and bottom three voted attributes as a guiding path to handhold them for future perfection. In one embodiment, once a user opens an account, they will have a very detailed dashboard 200 to review their campaign cycles. In one embodiment, the sender or reviewer can see a detailed analysis of his/her personal dashboard 200. For every typical category of the sender, a standard set of attributes are predefined under two sets of experience such as good and bad.

In one embodiment, the dashboard 200 comprises a list of names of each individual or professional along with their date of response. In one embodiment, the dashboard 200 further includes details of the total number of respondents who reverted RAT, top three attributes voted, bottom three attributes voted, benchmark CS in the sector, the confidence score of each individual or professional, and a graph. In one embodiment, the dashboard 200 also shows many parameters. In one embodiment, the dashboard 200 further includes a space for testimonials. In one embodiment, the space includes a watermark requesting the users to write about their experience in Confiscore. In one embodiment, the testimonial space is optional. In one embodiment, further the dashboard 200 requests the users to publish their confidence score on the homepage. In one embodiment, the dashboard 200 also requests the users to pay for the ad traffic. In one embodiment, the request shows the users with redirect to AD traffic option.

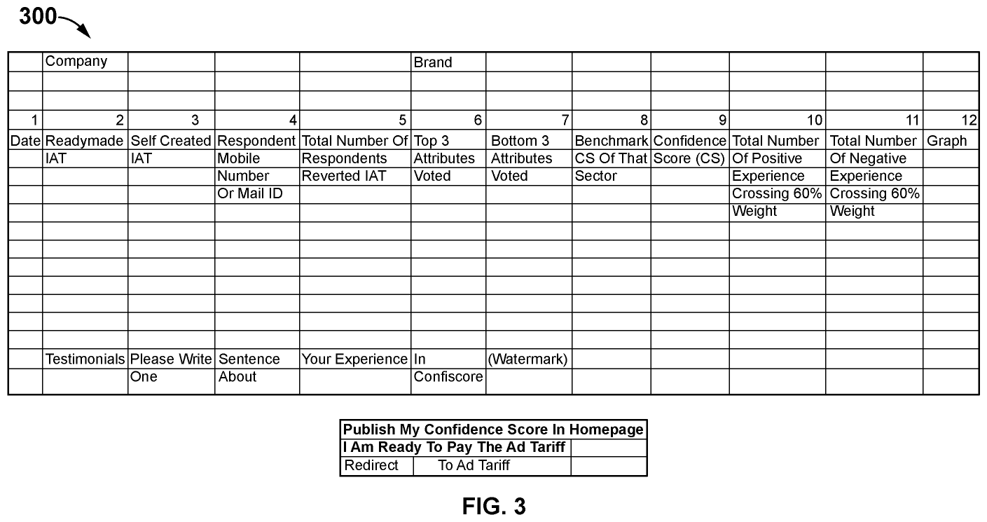

Referring to FIG. 3, shows a dashboard 300 for business and collective bodies, according to one embodiment. In one embodiment, the dashboard 300 comprises a list of names of their company, brand along with their date of response. In one embodiment, the dashboard 300 further includes details of readymade RAT, self-created RAT, respondent mobile number or e-mail ID, the total number of respondents reverted RAT, top three attributes voted, bottom three attributes voted, benchmark CS in the sector, the confidence score of each business or collective body, the total number of positive experiences, total number of negative experience and a graph. In one embodiment, the total number of positive experiences is evaluated based on the user response crossing 60% weight and the negative response is evaluated based on the user response not crossing 60% weight and above. In one embodiment, the dashboard 300 further includes a space for testimonials. In one embodiment, the space includes a watermark requesting the users to write about their experience in Confiscore. In one embodiment, the testimonial space is optional. In one embodiment, further the dashboard 300 requests the users to publish their confidence score on the homepage. In one embodiment, the dashboard 300 also requests the users to pay for the ad traffic. In one embodiment, the request shows the users with redirect to AD traffic option.

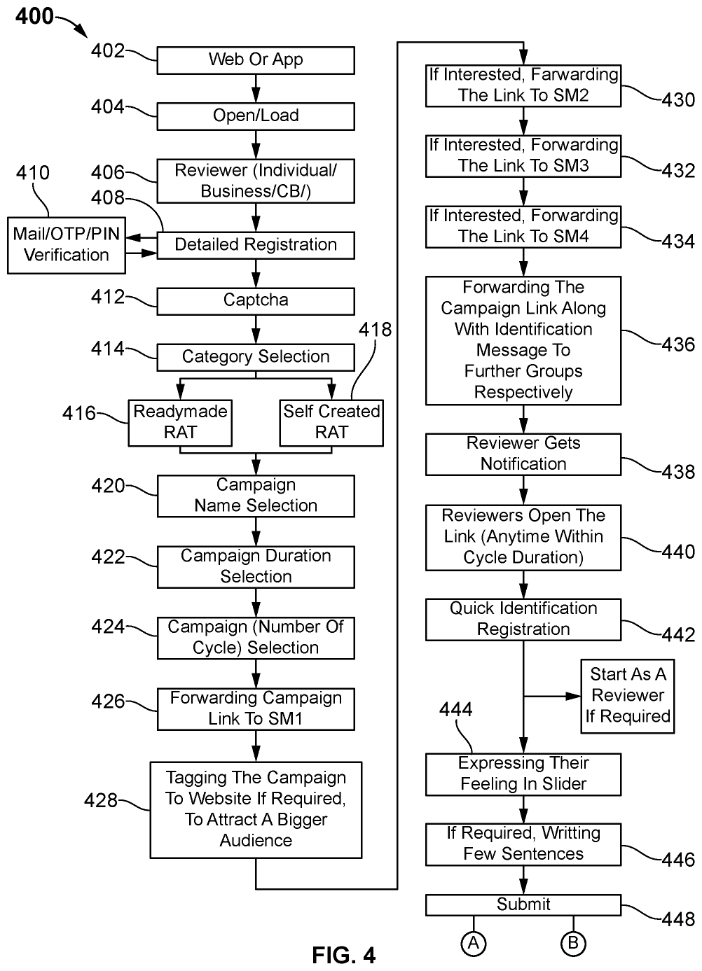

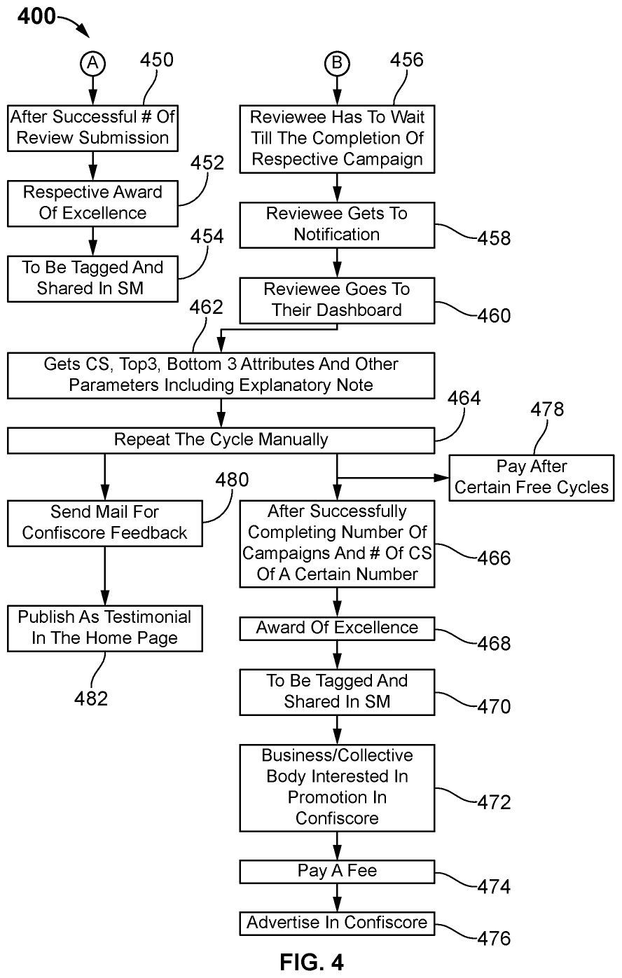

Referring to FIG. 4, a flowchart 400 describing the experience of reviewee (sender) and reviewer (responder) for measuring and monitoring acceptance of the reputation of a personal/professional or brand, according to one embodiment of the present invention. At step 402, the system is installed with a dedicated application software or digital platform. In one embodiment, the digital platform may be a mobile application or web-based application or desktop application. At step 404, the digital platform is opened/loaded in a user device. At step 406, the reviewee is allowed to run the digital platform. At step 408, the reviewee provides one or more user credentials for detailed registration into the application. In one embodiment, the reviewee may be an individual, business personal, CB, professionals, or any other users. At step 410, the registration is confirmed by sending a mail and one time password (OTP), and performing PIN verification. At step 412, the system allows the reviewee to enter a captcha upon successful registration for secured authentication.

At step 414, the system allows the reviewee to select the category of Reputation Assessment Template (RAT). At step 416, the reviewee may select a readymade RAT. At step 418, the reviewee may select a self-created RAT. At step 420, the system allows the reviewee to select a campaign name At step 422, a time duration for a campaign is selected. At step 424, number of cycles for each campaign is selected. At step 426, a link for the campaign is forwarded to a first social media (SM), for example, SM1. At step 428, the campaign may be tagged to the website/social media page, if required, thereby attracting more number of audiences. At step 430, the link shared in SM1 is forwarded to SM2, if interested. Similarly, at steps 432 and 434, if interested, the link is forwarded to the other social medias such as SM3 and SM4 respectively. At step 436, the campaign link is forwarded with an identification message to other groups.

At step 438, a reviewer/responder/respondent gets a notification from the reviewee. At step 440, the reviewer opens the link at any time within the cycle duration. At step 442, the system allows the reviewer to provide one or more user credentials for quick identification registration into the application. In one embodiment, the quick identification registration starts as a reviewee if required. At step 444, the reviewer expresses their feeling/response in the slider. At step 446, the reviewer may provide their response in one or more sentences if required. At step 448, the response is submitted to the reviewee. At step 450, after successful # of review, the response is submitted. At step 452, the system rewards the reviewer with an award of excellence. At step 454, the reward may be tagged and shared in the social media.

At step 456, the reviewee has to wait till the completion of respective campaign. At step 458, the reviewee gets a notification. At step 460, the reviewee goes to their dash board. At step 462, the reviewee gets CS, top three and bottom three attributes, and other parameters including explanatory note. At step 464, the above cycle is repeated manually, which includes steps 480-482. At step 466, the number of campaigns and # of CS of a certain number are successfully completed. At step 468, the system provides an award of excellence to the reviewee. At step 470, the reviewee may tag and share the award of excellence in any of their social media. At step 472, any user such as business personal or collective body who are interested in promotion in confiscore (CS) may visit the link. At step 474, the interested person has to pay a fee for promotion. At step 476, the user is advertised in confiscore. At step 478, the user has to pay after certain free cycles. At step 480, the system sends mail for the confiscore feedback. At step 482, the confiscore is published as testimonials in the home page.

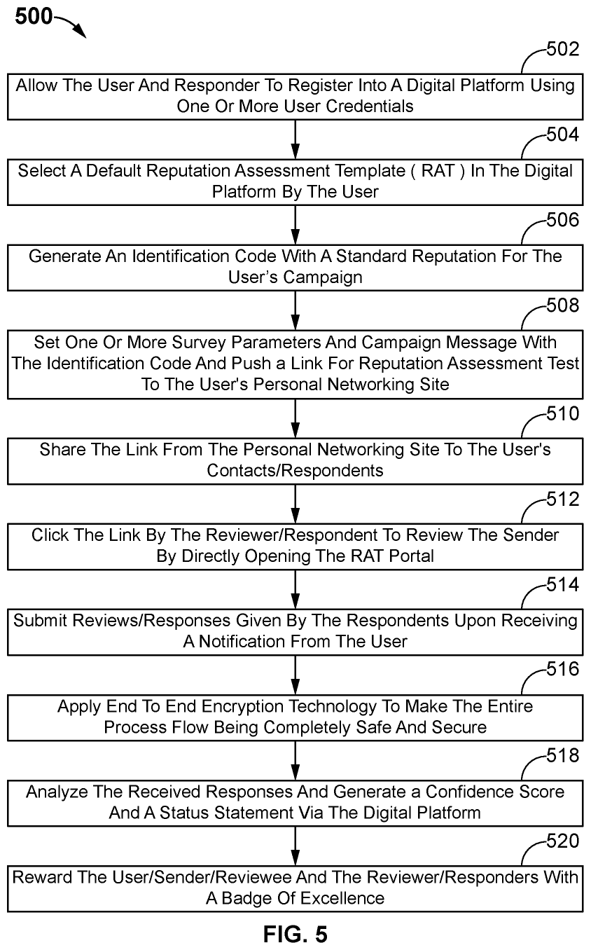

Referring to FIG. 5, a method for measuring and monitoring acceptance of a reputation or brand by a respondent, according to one embodiment. The method 500 uses a computing device having at least one processor and a memory in communication with the processor, wherein the memory stores a set of instructions executable by the processor. The system further comprises one or more databases in communication with the computing device via a network configured to store a plurality of responses received from the respondents. The system further comprises a user device associated with a user or sender in communication with the computing device via the network configured to fed or upload a reputation for analysis.

The method 500 comprises the following steps. At step 502, the system allows a user/reviewee/sender and responder/reviewer to register in a digital platform i.e., Confiscore APP or mobile web, using one or more user credentials. In one embodiment, the digital platform is an online survey tool. At step 504, the user selects a default Reputation Assessment Template (RAT) or modifies or creates a new RAT in the digital platform. At step 506, the system generates an identification code with a standard reputation for the user's campaign. At step 508, the user sets one or more survey parameters or campaign message with the identification code and push a link for reputation assessment test to the user's personal networking site. At step 510, the user shares the link from the personal networking site to the user's contacts i.e., the respondents. At step 512, the reviewer/respondent/responder clicks the link to go to RAT portal directly, with minimum name and phone registration for authenticity of survey. At step 514, the responders submit the reviews/responses by sliding the button of the attribute bar. At step 516, an end-to-end encryption technology is applied to make the entire process flow being completely safe and secure. At step 518, the digital platform analyzes the received responses and generates a confidence score via the digital platform along with a simple confidence status statement. At step 520, the digital platform rewards the user and the responders with a badge of excellence for their maximum effort.

Advantageously, the system of the present invention is a simple, fast, and convenient tool for analyzing the views of respondents on the personal or brand reputation. Further, the digital platform is simple to use for people of all ages and professions. It gives blazing fast analysis and results for the campaign. Moreover, it also provides strong and weak avenues for the professional, collective body or organization to work on. Through its user-friendly design and integration with various social media to share campaigns, it makes maintaining and working towards a better social reputation very convenient. Further, the interface is organized and easy to navigate.

The ultimate objective of Confiscore is introspection through the unbiased eyes of people. It is safe and secured as we use encrypted technology. All are interested to improve their self or brand reputation to create better credibility in the society which will ultimately translate into stronger influence and more business. The campaigns are more efficient than regular surveys because of their innovative and user-friendly interface that lets the users give valuable feedback with minimal effort. Also, the system solves all the problems in a fun-filled informal manner for business, collective body & professional/individual. In one embodiment, the reviewees need not struggle to frame any questions. For every profession or type of business. In one embodiment, the system of the present invention provides a readymade Reputation Assessment Template (RAT) available to make the survey process quick and easy. And also, the system allows easy modification of reputation templates (RAT). The present system makes it super easy to understand by publishing a confidence score, a number to signify good or bad.

The system further provides an anonymous and authentic review. In one embodiment, the system guarantees authentic reviews while also assuring the respondents of their anonymity. The respondents are given the freedom, to be honest, and give constructive feedback about their experience. Further, the system is used continuously to be in touch with the respondents to monitor and measure the real-time traits of any reviewee to improve their social connection and reputation. Moreover, the reviewers need not write anything primarily but just slide the pin in the bar in terms of a happy or unhappy experience with lightning speed.

In one embodiment, the user will only know his/her confidence score and nothing else about respondents. In one embodiment, further the system provides a badge of excellence once a respondent crosses a certain number of RAT responses, as a certificate of recognition. He can share and exhibit this in his/her social networking sites for people's knowledge and recognition. In on embodiment, the system further includes a trial plan with 10 campaign cycles with unlimited respondents for free. However, once the trial period is over, paid plan starts for each additional 10 campaign cycles and in multiples thereof, with unlimited respondents.

Preferred embodiments of this invention are described herein, including the best mode known to the inventors for carrying out the invention. It should be understood that the illustrated embodiments are exemplary only and should not be taken as limiting the scope of the invention.

The foregoing description comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings in the foregoing descriptions. Although specific terms may be employed herein, they are used only in generic and descriptive sense and not for purposes of limitation. Accordingly, the present invention is not limited to the specific embodiments illustrated herein.

What is claimed is:

1. A computer-implemented system executed in a network environment for measuring and monitoring social acceptance of reputation of a personal/professional or brand among respondents, comprising:
a computing device having one processor and a memory in communication with the processor, wherein the memory stores a set of instructions executable by the processor;
databases in communication with the computing device via a network configured to store responses received from the respondents,
a user device associated with a user or sender in communication with the computing device via the network configured to fed or upload a reputation for analysis, and
a response analyzing system, the user device is enabled to access the response analyzing system via the network, wherein the computing device is configured to,
allow the user and responder to register into a digital platform using user credentials;
select a default Reputation Assessment Template (RAT) in the digital platform by the user;
generate an identification code with a standard reputation for the user's campaign;
set survey parameters and campaign message with the identification code and push a link for reputation assessment test to the user's personal networking site, wherein the campaign is live for a time span or campaign cycle set by the user to accommodate maximum number of respondents possible, and wherein the campaign cycle varies for each campaign based on the number of campaign cycles set by the user in order to make the customer business relationship live and real time for continuous improvement of service;
share the link from the personal networking site to the user's contacts or respondents;
click the link by the reviewer/respondent to go to Reputation Assessment Template (RAT) portal directly, with minimum name and phone registration for authenticity of survey;
submit reviews or responses given by the respondents upon receiving a notification from the user, wherein the system allows the respondents to furnish an honest review by sliding a button of an attribute bar to submit the response in terms of either good or bad experience in a zero writing or typing method to enhance the speed of the survey in an effortless way without affecting the relationship with the reviewee by maintaining anonymity of the reviewer;
apply end to end encryption technology to make the entire process flow being completely safe and secure;
analyze the received responses and generate a confidence score and a status statement via the digital platform, wherein the digital platform converts the responses given by the responders into a numeric value of confidence score using a formula that is normalized and calibrated in such a way that the confidence score is skewed in case of a less or greater number of attributes and respondents ,and
reward the user or sender or reviewee and the reviewer or responders with a badge of excellence, characterized by:
the system executed in a network environment calculates the confidence score by picking up the submitted Reputation Assessment Template (RAT) parameters depending on the sector at a specific interval after the end of every campaign cycle with a written single statement for explaining the real meaning of confidence status in simple language, and the system executed in a network environment calculates a benchmark confidence score in real time automatically as an industry or sector or professional standard for a particular type of business or sector, collective body, and individual profession respectively, so that a particular reviewee view the confidence score in their personal dash board and act upon for improvement, wherein the user or reviewee also gets to know about three top and bottom voted attributes in terms of strengths and weaknesses along with confidence score to guide them to the path of improvement.

2. The computer-implemented system executed in a network environment of claim 1, wherein the user modifies the default Reputation Assessment Template (RAT) or creates a new Reputation Assessment Template (RAT).

3. The computer-implemented system executed in a network environment of claim 1, wherein the user sends the campaign notification to the responders through e-mail, all social networking sites, or any other suitable messaging applications with the identification code.

4. The computer-implemented system executed in a network environment of claim 1, wherein the user or sender is an individual, professional, banker, architect, entity, collective body, business, and others.

5. The computer-implemented system executed in a network environment of claim 1, wherein the respondents are a friend, colleague, client, customer, user, or their business or brand.

6. The computer-implemented system executed in a network environment of claim 1, generates a compressive report to monitor the change of responders' view over time.
